(19) United States
(12) Patent Application Publication
(10) Pub. No.: US 2012/0284701 A1
(43) Pub. Date: Nov. 8, 2012

(54) EFFICIENT CONDITIONAL FLOW CONTROL COMPILATION

(75) Inventors: Ming-Chang Tsai, San Diego, CA (US); Chihong Zhang, San Diego, CA (US)

(73) Assignee: QUALCOMM Incorporated, San Diego, CA (US)

(21) Appl. No.: 13/102,462

(22) Filed: May 6, 2011

(51) Int. Cl. G06F 9/45

(52) U.S. Cl. 717/151

(57) ABSTRACT

In general techniques are described for efficient conditional flow control (CFC) compilation. An apparatus comprising a processor executing a compiler that includes at least one translation module may perform these techniques. The translation module translates a first set of high-level (HL) CFC software to a functionally equivalent but different second set of HL CFC software instructions. The compiler then compiles the first and second sets of high-level CFC software instructions to respective first and second sets of low-level (LL) CFC software instructions. An evaluation module of the compiler evaluates the first and second sets of LL CFC software instructions to determine which of the first and second sets of the low-level CFC software instructions is more efficient as measured in terms of at least one execution metric and outputs the one of the first and second low-level CFC software instructions determined to be most efficient.

### TECHNICAL FIELD

This disclosure relates to computing devices and, more particularly, the generation of instructions for execution by computing devices.

### BACKGROUND

Compilers are computer programs that generate low-level software instructions, such as those defined by various machine or assembly computer programming languages, from high-level software instructions, such as those defined in accordance with various so-called high-level computer programming languages (e.g., C, C++, Java, Basic and the like). A computer programmer typically defines a computer program using high-level software instructions and invokes the compiler to generate low-level software instructions corresponding to the high-level software instructions that are executable by any given computing device that supports execution of the low-level software instructions. In this way, the compiler compiles the high-level software instructions to generate the low-level software instruction so that any given computing device may execute the computer program defined by the computer programmer using software instructions defined in accordance with a high-level programming language.

### SUMMARY

In general, this disclosure describes techniques for efficient conditional flow control compilation. The phrase “conditional flow control” generally refers to a set of instructions defined in accordance with a high-level programming language directed to controlling the flow of execution of the high-level software instructions that form a computer program based on some conditional statement. In these high-level programming languages that provide for conditional flow control instruction sets, there are often a number of different conditional flow control instructions sets that may be used by a computer programmer to achieve the same flow control.

When compiling these different conditional flow control instruction sets, the techniques described in this disclosure enable a compiler to select low-level software instructions that may most efficiently represent the conditional flow control provided by the high-level conditional flow control software instructions. In other words, rather than statically map the high-level conditional flow control instructions to a certain set of low-level software instructions that may or may not be the most efficient representation of these high-level software instructions, the techniques may enable the compiler to evaluate multiple sets of low-level software instructions that each represent the high-level flow control software instructions and select a set from among all of the multiple sets of low-level software instructions. In some examples, the selected set may be the most efficient set, e.g., in terms of computational efficiency. In this manner, the techniques may provide for efficient conditional control flow compilation with respect to conventional conditional flow control compilation.

In one aspect, a method of compiling high-level software instructions to generate low-level software instructions comprises translating, with a computing device, a first set of the high-level conditional flow control (CFC) software instructions to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions. The method further comprises compiling, with the computing device, the first and second sets of high-level CFC software instructions to a respective first and second set of low-level CFC software instructions, determining, with the computing device, which of the first and second sets of the low-level CFC software instructions is more efficient as measured in terms of at least one execution metric and selecting, with the computing device, the one of the first and second low-level CFC software instructions determined to be more efficient, wherein the low-level software instructions include the one of the first and second sets of the low-level CFC software instructions that is determined as more efficient.

In another aspect, An apparatus that compiles high-level software instructions to generate low-level software instructions comprises a processor that executes a compiler to translate a first set of high-level conditional flow control (CFC) software instructions included within the high-level software instructions to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions. The compiler further compiles the first and second sets of high-level CFC software instructions to a respective first and second set of low-level CFC software instructions. The compiler includes an evaluation module that determines which of the first and second sets of the low-level CFC software instructions is more efficient as measured in terms of at least one execution metric and selects the one of the first and second low-level CFC software instructions determined to be most efficient, wherein the low-level software instructions include the one of the first and second sets of the low-level CFC software instructions that is determined as most efficient.

In another aspect, an apparatus that compiles high-level software instructions to generate low-level software instructions comprises means for translating a first set of high-level conditional flow control (CFC) software instructions included within the high-level software instruction to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions. The apparatus further comprises means for compiling the first and second sets of high-level CFC software instructions to a respective first and second set of low-level CFC software instructions, means determining which of the first and second sets of the low-level CFC software instructions is most efficient as measured in terms of at least one execution metric and means for selecting the one of the first and second low-level CFC software instructions determined to be most efficient, wherein the low-level software instructions include the one of the first and second sets of the low-level CFC software instructions that is determined as more efficient.

In another aspect, a non-transitory computer-readable medium comprising instructions that cause, when executed, one or more processors to translate a first set of high-level conditional flow control (CFC) software instructions included within the high-level software instruction to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions, compile the first and second sets of high-level CFC software instructions to a respective first and second set of low-level CFC software instructions, determine which of the first and second sets of the low-level CFC software instructions is most efficient as measured in terms of at least one execution metric and select the one of the first and second low-level CFC software instructions determined to be most efficient, wherein the low-level software instructions include the one of the first and second sets of the low-level CFC software instructions that is determined as more efficient.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a development system that implements an example of the efficient conditional flow control (CFC) compilation techniques described in this disclosure.

FIG. 2 is a block diagram illustrating CFC translation manager module of FIG. 1 in more detail.

FIG. 3 is a flowchart illustrating example operation of a compiler in implementing various aspect of the efficient CFC compilation techniques described in this disclosure.

FIG. 4 is a block diagram illustrating another computing device that may implement the techniques described in this disclosure.

### DETAILED DESCRIPTION

In general, this disclosure describes techniques for efficient conditional control flow (CFC) compilation. The phrase “conditional flow control” generally refers to a set of instructions defined in accordance with a high-level (HL) programming language directed to controlling the flow of execution of the HL software instructions that form a computer program based on some conditional statement. In these HL programming languages that provide for CFC instruction sets, there are often a number of different CFC instructions sets that may be used by a computer programmer to achieve the same flow control.

For example, one set of HL CFC instructions generally involve the use of an “if” instruction followed by a conditional statement. This conditional statement is usually defined as a Boolean statement using Boolean operators. One example conditional statement may involve a Boolean comparison to determine whether a current value of a variable is greater than a given value, which may be expressed as “x>10,” where the variable is represented as x in this statement with the greater than operator being defined as the character ‘>.’ This statement is Boolean in that it returns a Boolean value of either “true” (which is usually defined as one) or “false” (which is usually defined as zero). Following this “if” instruction are one or more additional instructions. If the conditional statement is true, the additional instructions are performed. If the conditional statement is false, the additional instructions are skipped or not performed and the flow of execution resumes after the additional instructions.

Other types of HL CFC instruction sets include those defined using an “if” instruction followed by “else” instructions (commonly referred to as “if-else” CFC instructions), those defined using the operator “:?” and those defined using multiple “if” statements (commonly referred to as “if-if” CFC instructions). The techniques of this disclosure also may provide for additional CFC instruction sets that are not commonly employed in conventional HL programming languages, such as HL CFC instruction sets involving linear interpolation and polynomial fitting. These HL CFC instruction sets provided by the techniques generally leverage mathematical instructions to evaluate Boolean expressions and thereby provide for CFC. The techniques may enable the addition of these and other HL CFC instruction sets in an extensible manner in that the techniques may adapt a compiler to provide an interface by which these and other HL CFC instruction sets may be added. The compiler may compile these additional HL CFC instruction sets in a more efficient manner than those HL CFC instructions sets explicitly defined by the high-level programming language. In this respect, the techniques may facilitate more efficient CFC compilation.

In addition, when compiling these different CFC instruction sets, the techniques enable a compiler to select low-level (LL) software instructions that may most efficiently represent the CFC provided by the HL CFC software instructions sets. In other words, rather than statically map the HL CFC instructions to a certain set of LL software instructions that may or may not be the most efficient representation of these HL software instructions, the techniques may enable the compiler to evaluate multiple sets of LL software instructions that each represent to the same extent the HL CFC software instructions and select the most efficient set from among all of the multiple sets of LL software instructions. In this manner, the techniques may also provide for efficient CFC compilation with respect to conventional CFC compilation.

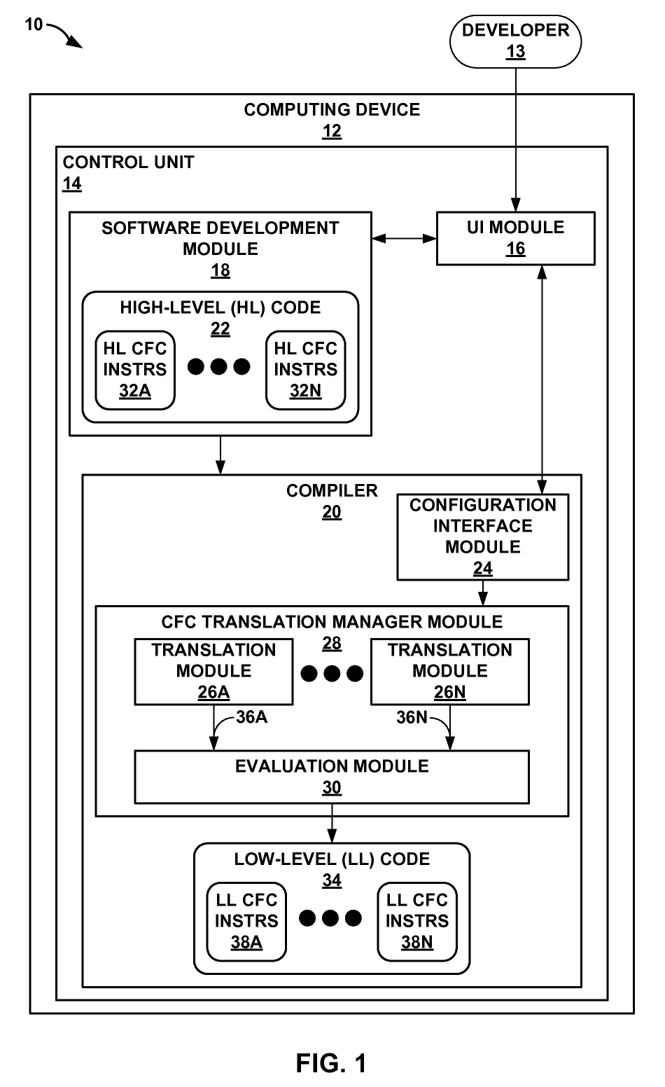

FIG. 1 is a block diagram illustrating a development system 10 that implements the efficient conditional flow control (CFC) compilation techniques described in this disclosure. In the example of FIG. 1, development system 10 includes a computing device 12. Computing device 12 may comprise a desktop computer, a laptop computer (including so-called “netbook” computers), a workstation, a slate or tablet computer, a personal digital assistant (PDA), a mobile or cellular phone (including so-called “smart phones”), a digital media player, a gaming device, or any other device with which a user, such as developer 13, may interact to define high-level (HL) code and then compile HL code to generate LL code. In this disclosure, the term “code” generally refers to a set of one or more software instructions that define a computer program, software or other executable file.

Compute device 12 includes a control unit 14. Control unit 14 may comprise one or more processors (not shown in the example of FIG. 1) that execute software instructions, such as those used to define a software or computer program, stored to a computer-readable storage medium (again, not shown in the example of FIG. 1), such as a storage device (e.g., a magnetic hard disk drive, solid state drive, or an optical drive), or memory (such as Flash memory, random access memory or RAM) or any other type of volatile or non-volatile memory, that stores instructions to cause a programmable processor to perform the techniques described herein. Alternatively, control unit 14 may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of one or more of the foregoing examples of dedicated hardware, for performing the techniques described herein.

Control unit 14 executes or otherwise implements a user interface (UI) module 16, a software development module 18 and a compiler 20. UI module 16 represents a module that presents a user interface with which a user, such as developer 13, may interface to interact with software development module 18 and compiler 20. UI module 16 may present any type of user interface, such as a command line interface (CLI) and/or a graphical user interface (GUI), with which developer 13 may interact to interface with modules 18 and 20.

Software development module 16 represents a module that facilitates the development of software in terms of a HL programming language. Typically, software development module 18 presents one or more user interfaces via UI module 16 to developer 13, whereby developer 13 interacts with these user interfaces to define software in the form of high-level (HL) code 22. Again, the term “code” as used in this disclosure refers to a set of one or more software instructions that define a computer program, software or other executable file. HL code 22 typically represents instructions defined in what is commonly referred to as a HL programming language. An HL programming language generally refers to a programming language with strong abstraction from the underlying details of the computer, such as memory access models of processors and management of scope within processors.

HL programming languages generally provides for a higher level of abstraction than low level (LL) programming languages, which is a term that generally refers to machine programming languages and assembly programming languages. Examples of HL programming languages include a C programming language, a so-called “C++” programming language, a Java programming language, visual basic (VB) programming language, an Open Graphics Library (GL) programming language, an Open GL Embedded Systems (ES) programming language, and a Basic programming language. Many HL programming languages are object-oriented in that they enable the definition of objects (which is generally considered a computer science term for data structures) capable of storing data and open to manipulation by algorithms in order to abstractly solve a variety of problems without considering the underlying architecture of the computing device.

Compiler 20 represents a module that reduces HL instructions defined in accordance with a HL programming language to LL instructions of a LL programming language, where these LL instructions are capable of being executed by specific types of processors or other types of hardware, such as FPGAs, ASICs, and the like. LL programming languages are considered low level in the sense that they provide little abstraction, or a lower level of abstraction, from an instruction set architecture of a processor or the other types of hardware. LL languages generally refer to assembly and/or machine languages. Assembly languages are a slightly higher LL language than machine languages but generally assembly languages can be converted into machine languages without the use of a compiler or other translation module. Machine languages represent any language that defines instructions that are similar, if not the same as, those natively executed by the underlying hardware, e.g., processor, such as the x86 machine code (where the x86 refers to an instruction set architecture of an x86 processor developed by Intel Corporation).

Compiler 20 in effect translates HL instructions defined in accordance with a HL programming language into LL instructions supported by the underlying hardware and removes the abstraction associated with HL programming languages such that the software defined in accordance with these HL programming languages is capable of being more directly executed by the actual underlying hardware. Typically, compilers, such as compiler 20, are capable of reducing HL instructions associated with a single HL programming language into LL code, such as LL code 24 comprising instructions defined in accordance with one or more LL programming languages, although some compilers may reduce HL instructions associated with more than one HL programming language into LL instructions defined in accordance with one or more LL programming languages.

While software development module 18 and compiler 20 are shown as separate modules in the example of FIG. 1, often software development module 18 and compiler 20 are combined in a single module referred to commonly as an integrated development environment (IDE). The techniques of this disclosure should not be limited in this respect to separate modules 18 and 20 shown in the example of FIG. 1, but may apply to instances where these are combined, such as in an IDE. With an IDE, developers may both define software using HL instructions and generate an executable file comprising LL instructions capable of being executed by a processor or other types of hardware by employing the compiler to translate the HL instructions into the LL instructions. Typically, IDEs provide a comprehensive GUI with which developers may interact to define and debug the software defined using HL instructions, compile the HL instructions into LL instructions and model execution of the LL instructions so as to observe how execution of the LL instructions would perform when executed by hardware either present within the device or present within another device, such as a cellular phone.

For example, the Open GL ES programming language is a version of Open GL (which was developed for execution by desktop and laptop computers) that is adapted for execution not on personal computers, such as desktop and laptop computers, but on mobile devices, such as cellular phones (including so-called smart phones), netbook computers, tablet computers, slate computers, digital media players, gaming devices, and other portable devices. Open GL and, therefore, Open GL ES provide for a comprehensive architecture by which to define, manipulate and render both two-dimensional (2D) and three-dimensional (3D) graphics. The ability to model these mobile devices, which may have processors that have vastly different instruction set architectures than those common in personal computers, within an IDE has further increased the desirability of IDEs as a development environment of choice for developers seeking to develop software for mobile devices. While not shown in the example of FIG. 1, control unit 14 may also execute or implement a modeler module capable of modeling the execution of LL software instructions by hardware that is often not natively included within computing device 12, such as mobile processors and the like.

In any event, one function of compilers, such as compiler 20, involves translation of conditional flow control (CFC) instructions defined in accordance with a HL programming language into CFC instructions defined in accordance with a LL programming language. CFC instructions refer to any instruction by which the flow of execution of the instructions by the processor may be controlled. For example, many HL programming languages specify an “if” instruction whose syntax commonly requires a definition of a conditional statement following the invocation of this “if” instruction. This conditional statement is usually defined as a Boolean statement using Boolean operators. One example conditional statement may involve a Boolean comparison to determine whether a current value of a variable is greater than a given value, which may be expressed as “x>10,” where the variable is represented as ‘x’ in this statement with the greater than Boolean operator being defined as the character ‘>.’ This statement is Boolean in that it returns a Boolean value of either “true” (which is usually defined as one) or “false” (which is usually defined as zero). Following this “if” instruction is one or more additional instruction, and if the conditional statement is true, the additional instructions are performed. If the conditional statement is false, the additional instructions are skipped or not performed and the flow of execution resumes after the additional instructions. In this sense, the “if” instruction conditions and thereby controls the execution of the additional instructions upon the evaluation of conditional, often Boolean, statement. For this reason, the “if” instruction is commonly referred to as a CFC instruction.

Other types of HL CFC instruction sets include those defined using an “if” instructions followed by “else” instructions (commonly referred to as “if-else” CFC instructions), those defined using the operator “:?” and those defined using multiple “if” statements (commonly referred to as “if-if” CFC instructions). In “if-else” instruction sets, the “if” instruction is the same as that discussed above, but the flow or control of execution is modified by the “else” statement such that when the conditional statement following the “if” is false, a second set of additional instructions following the “else” instruction is executed. This second set of additional instructions is only executed if the conditional statement following the “if” instruction is false, thereby providing a further level of control over the execution of instructions. The “:?,” instruction generally refers to a ternary operator that mimics the “if-else” instructions. This instruction may also be commonly known as the “?:” instruction. Typically, the “?” instruction or operator is preceded by a conditional, and often Boolean, statement and directly followed by a value to be assigned to a variable if the conditional statement is true. This “true” value is then followed by the “:” instruction or operator, which is in turn followed by a value to be assigned to a variable if the conditional statement is false. The “if-if” instruction sets generally refer to a sequence of “if” statements that are the same or at least similar in form to the “if” statements defined above. The “if-if” instruction sets may be employed in a manner similar to that of “if-else” instruction sets, such as when a first “if” instruction is followed by a certain conditional statement and a set ‘if’ instruction following the first has the inverse of the conditional statement defined for the first “if” instruction.

As noted above, many of these CFC instruction sets permit substantially similar types of CFC over the execution of instructions. That is, “if” CFC instruction sets may be defined in a manner that provides the same type of CFC as “if-else” instruction sets, “:?” instruction sets, and “if-if” instruction sets. Likewise, “if-else” instruction sets may be defined in a manner that provides the same type of CFC as “if” instruction sets, “:?” instruction sets, and “if-if” instruction sets. Furthermore, “:?” CFC instruction sets may be defined in a manner that provides the same type of CFC as “if” instruction sets, “if-else” instruction sets and “if-if” instruction sets. In addition, “if-if” CFC instruction sets may be defined in a manner that provides the same type of CFC as “if” instruction sets, “if-else” instruction sets and “:?” instruction sets.

However, while these different types of CFC instruction sets may be defined to provide the same type of CFC, compilers generally provide for different translations between the different sets of HL CFC instructions and sets of LL CFC instructions. That is, a compiler may translate an “if” HL CFC instruction set that provides a given type of CFC to a first set of LL CFC instructions but translate an “if-else” HL CFC instruction set that provides the same type of CFC to a different second set of LL CFC instructions. The first set of LL CFC instructions may, in some examples, represent a more efficient set of LL CFC instructions (as measured in terms of a combination of one or more of a number of low-level instructions, memory consumed by the low-level instructions and general purpose registers utilized per thread) than the different second set of LL CFC instructions in terms of a combination of one or more of a number of low-level instructions, memory consumed by the low-level instructions and general purpose registers utilized per thread. In this sense, these compilers statically map a given set of HL CFC instructions to a set of LL CFC instructions without considering alternative expressions of the HL CFC instruction set using different types of HL CFC instructions sets. This results in inefficiencies that may impact overall execution of the resulting executable file compiled by the compiler.

In accordance with the efficient CFC compilation techniques described in this disclosure, compiler 20 provides a configuration interface module 24 with which a developer, such as developer 13, may interact to define one or more translation modules 26A-26N (“translation modules 26”). Configuration interface module 24 represents a module that provides one or more user interfaces to user interface module 16 with which developer 13 interacts to define one or more of translation modules 26. Compiler 20 also includes, in accordance with the efficient CFC compilation techniques described in this disclosure, a CFC translation manager module 28 that represents a module for managing translation modules 26.

Rather than statically define translations between a single type of CFC instruction set and a single type of LL CFC instruction sets, configuration interface module 24 enables developer 13 to define any number of translation modules 26 that each represent a different translation of a first type HL CFC instruction set to a second type of HL CFC instruction set. CFC translation manager module 28 then invokes each of translation modules 26 to translate a defined HL CFC instruction set of one type into equivalent HL CFC instruction sets of one or more different types. CFC translation manager module 28 includes an evaluation module 30 representing a module that compiles each of these HL CFC instruction sets into the LL CFC instruction sets and evaluates each of the LL CFC instruction sets to select the most efficient LL instruction set, where efficiency is again measured in terms of a combination of one or more of a number of low-level instructions, memory consumed by the low-level instructions and general purpose registers utilized per thread, as well as, a number of unused general purpose registers. In this way, rather than statically map each type of HL CFC instruction sets to a particular LL CFC instruction set, the techniques enable evaluation of all available equivalent HL CFC instruction sets with the result of selecting potentially the most efficient LL CFC instruction set available for a particular type of CFC.

Moreover, the techniques enable an extensible environment in that developer 13 may define translations of a given type of conventional HL CFC instruction set, such as an “if” HL CFC instruction set, to unique HL CFC instruction sets that were not previously provided as typical HL CFC instruction sets. For example, developer 13 may define a translation from any given conventional HL CFC instruction set to a HL CFC instruction set that employs linear interpolation or polynomial fitting as its conditional statement. These unconventional HL CFC instruction sets may compile into LL CFC instruction sets that are more efficient than the conventional HL CFC instruction sets. In this manner, additional translation modules may be defined and used to produce competing but functionally equivalent HL CFC instruction sets to improve the efficiency of the resulting LL CFC instruction sets. These efficiency increases may improve execution of the resulting LL code in terms of power consumption and processor utilization considering that these efficiencies may reduce memory access and the number of LL instructions that need to be executed to achieve the desired functionality.

To illustrate, developer 13 may initially interact with a user interface of configuration interface module 24 presented by UI module 16 to specify translation modules 26. CFC translation manager module 28 stores these translation modules 26 and may verify these translation modules 26 for syntax and other errors. Developer 13 may then interface with a user interface of software development module 18 presented via UI module 16 to specify HL code 22. In particular, developer 13 may specify HL code 22 that includes HL CFC instruction (“instrs”) sets 32A-32N (“HL CFC instrs 32A-20N, which may be collectively referred to as “HL CFC instruction sets 32”).

After defining HL code 22, developer 13 invokes compiler 20 to compile HL code 22. Compiler 20 receives HL code 22, and compiles HL code 22 to generate LL code 34, which may comprise code defined in accordance with machine, assembly or other low level programming languages. During compilation of HL code 22, compiler 20 compiles HL CFC instruction sets 32. For each of HL CFC instruction sets 32, compiler 20 invokes CFC translation manager module 28 and passes each of CFC instruction sets 32 to CFC translation manager module 28. CFC translation manager module 28 receives each of HL CFC instruction sets 32 and invokes translation modules 26 to translate each of HL CFC instructions sets 32 into functionally equivalent but different HL CFC instruction sets 36A-36N (“functionally equivalent HL CFC instruction sets 36”). In this way, each of translation modules 26 translates a first set of high-level conditional flow control (CFC) software instructions to a functionally equivalent but different second set of high-level CFC software instructions that control the flow of execution of the remaining HL instruction so of the HL code 22 in the same manner as the first set of high-level CFC software instructions.

After generating functionally equivalent HL CFC instruction sets 36, CFC translation manager module 28 invokes evaluation module 30, which compiles the one of HL CFC software instructions 32 to a first set of low-level CFC software instructions and each of the functionally equivalent HL CFC software instructions 36 to corresponding additional sets of LL CFC software instructions. Evaluation module 30 then evaluates the various sets of LL CFC software instructions to determine which of the various LL CFC software instructions is more efficient as measured in terms of at least one the above mentioned execution metrics, such as a number of low-level instructions, memory consumed by the low-level instructions and general purpose registers utilized per thread. Evaluation module 30 then outputs the one of the various sets of LL CFC software instructions determined to be most efficient, storing the corresponding sets of LL CFC software instruction to LL code 34, where each of HL CFC instruction sets 32 correspond to a different one of LL CFC instructions sets 38A-38N (“LL CFC instruction sets 38,” which are shown in the example of FIG. 1 as “LL CFC instrs 38”).

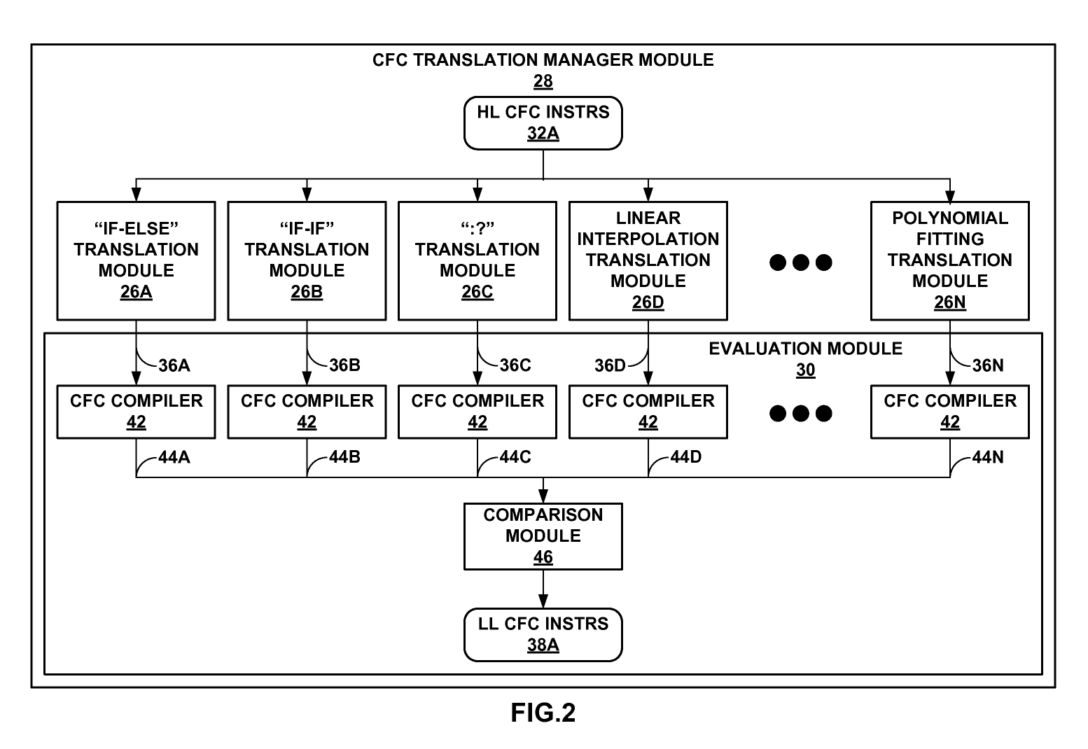

FIG. 2 is a block diagram illustrating CFC translation manager module 28 of FIG. 1 in more detail. CFC translation manager module 28 includes above noted translation modules 26, which have been shown in further detail in the example of FIG. 2. For example, translation module 26 is shown as “if-else” translation module 26A in the example of FIG. 2, where the “if-else” term refers to the particular type of translation resulting from translation performed by this module 26A. That is, translation module 26A transforms exemplary HL CFC instruction set 32A, which may be assumed for the purposes of example to represent a CFC instruction set of “if-if” type, to HL CFC instruction set 36A of a particular type of CFC instruction set employing “if-else” instructions. Likewise, translation module 26B transforms exemplary HL CFC instruction set 32A, which in this instance may be assumed for purposes of example to represent a CFC instruction set of “if-else”, to HL instruction set 36B of a particular type of CFC instruction set employing “if-if” instructions. In addition, translation modules 26C-26N translate exemplary HL CFC instruction set 32A to HL CFC instructions sets 36C-36N of a particular type employing “:?” instructions, linear interpolation instructions and polynomial fitting instructions, respectively. While described with respect to these exemplary translations, the techniques may involve any number of translations, hence the enumeration of translation modules 26 as being any number as signified by the numeral 26N.

Both linear interpolation translation module 26D and polynomial fitting translation module 26N may represent modules that each perform translations to HL CFC instruction sets that are adapted for execution by a special purpose processor, such as a graphics processing unit (GPU), capable of performing certain mathematical operations more efficiently than a general purpose processor that is not typically suited for such operations, such as a central processing unit (CPU). Linear interpolation translation module 26D may, for example, translate HL CFC instruction set 32A into a HL CFC instruction set 36D that employs a so-called “mix( )” function or instructions supported by some GPUs or other types of processors or hardware. This mix( ) function in effect implements a cascaded form of linear interpolation. Linear interpolation translation module 26D may employ this “mix( )” instruction to provide for conditional control flow, in some instances, more efficiently than other HL CFC instruction sets of conventional types, such as the above noted “if-if” type, “if-else” type and “:?” type. The mix( ) instruction may be specially implemented by certain processors and/or hardware in a highly parallelized manner such that multiple comparisons may occur concurrently, thereby improving the speed with which comparisons required to perform CFC may be performed. This mix( ) function is typically provided by GPUs for rendering points or values between two or more points or values, or in other words, for performing curve fitting using linear polynomials.

Polynomial fitting translation module 26N represents a module that may be more general than the linear interpolation module in that it employs polynomials generally instead of only linear forms of polynomials. Polynomial fitting translation module 26N translates HL CFC instruction set 32A into a particular type of HL CFC instruction set 36N that includes instructions to instantiate a matrix. The resulting HL CFC instruction set 36N may also include a “dot” instruction that causes GPUs that support matrix mathematics to perform matrix multiplication multiplying the instantiated matrix by at least one value. The matrix multiplication may effectively reduce a cascade of comparisons to a single efficient operation capable of being performed by a GPU in fewer clock cycles than those necessary to perform other types of HL CFC instructions, such as the above noted “if-if” type, “if-else” type and “:?” type, with a CPU. Consequently, in some instances, both linear interpolation HL CFC instruction set 36D and polynomial fitting HL CFC instruction set 36N may be compiled into more efficient LL CFC instructions than the other above noted types, resulting in more efficient LL code 34.

CFC translation manager module 28 also includes an evaluation module 30. Evaluation module 30 represents a module that performs the evaluation described above to select the most efficient LL CFC instruction set, where again efficiency may be measured in terms of a combination of one or more of a number of low-level instructions, memory consumed by the low-level instructions and general purpose registers utilized per thread. Evaluation module 30 includes CFC compilers 42 that each compile a different set of translated HL CFC instructions 36 output from translation modules 26. While shown as including a CFC compiler 42 for each of translation modules 26, evaluation module 30 may include a single CFC compiler 42 or any number of CFC compilers 42. In instances where evaluation module 30 includes a single CFC compiler 42, this CFC compiler 42 compiles each of translated HL CFC instructions sets 36 serially to produce candidates LL CFC instructions sets 44A-44N (“candidate LL CFC instruction sets 44”). If evaluation module 30 includes more than one CFC compiler 42 but less than the number of translation modules 26, then these CFC compilers 42 function both concurrently to process one or more of translated HL CFC instruction sets 36 but also serially in that each of CFC compilers 42 may compile more than one translated HL CFC instruction sets 36. In the example shown in FIG. 2, CFC compilers 42 may each process a respective one of HL CFC instruction sets 36 at least partially concurrently and output candidate LL CFC instruction sets 44.

Evaluation module 30 further includes a comparison module 46 that performs the comparison of each of candidate LL CFC instruction sets 44 and selects, in terms of the above noted execution metrics, the one of candidate LL CFC instruction sets 44 that is most efficient. Evaluation module 30 outputs the selected most efficient one of candidate LL CFC instruction sets 44 as LL CFC instruction 38A, as shown in the example of FIG. 2.

As described above, translation modules 26 may be defined and dynamically loaded into compiler 20 via configuration interface module 24. Specification of the various translation modules 26 shown in the example of FIG. 2 may resemble the compiler directives identified below. Compiler directives refer to code provided by developer 13 in HL code 22 that instruct or otherwise direct the compiler to perform a specific compilation, where in this instance the specific compilation is to use the specific type of HL CFC instructions identified by each of the five compiler directives listed below.

#ifdef USING_MIX

result = arith_expr_1;
result = mix( arith_expr_2, result, float( cond == val_2 ) );
result = mix( arith_expr_3, result, float( cond == val_3 ) );
result = mix( arith_expr_4, result, float( cond == val_4 ) );

#endif
#ifdef USING_MATRIX
mat4 sel_1 = mat4( coef_11, coef_12, coef_13, coef_14,
coef_21, coef_22, coef_23, coef_24,
coef_31, coef_32, coef_33, coef_34,
coef_41, coef_42, coef_43, coef_44 );
result_1 = dot( vec4( 1.0, cond, cond*cond, cond*cond*cond ) * sel_1,
input );
....
// more codes depending on arith_expr_1/2/3/4
#endif
#ifdef USING_IF_ELSE

result = arith_expr_1;
if( cond == val_2 ) result = arith_expr_2;
else if( cond == val_3 ) result = arith_expr_3;
else if( cond == val_4 ) result = arith_expr_4;

#endif
#ifdef USING_IF_IF

result = arith_expr_1;
if( cond == val_2 ) result = arith_expr_2;
if( cond == val_3 ) result = arith_expr_3;
if( cond == val_4 ) result = arith_expr_4;

#endif
#ifdef USING_SELECTION

result = arith_expr_1;
result = (cond == val_2) ? arith_expr_2 : result;
result = (cond == val_3) ? arith_expr_3 : result;
result = (cond == val_4) ? arith_expr_4 : result;

#endif

In the compiler directives above, the expression “#ifdef” identifies the start of each compiler directive, while the “#endir” expression identifies the end of each compiler directive. The phrase following the “#ifdef” expression, i.e., “USING_MIX,” “USING_MATRIX,” “USING_IF_ELSE,” “USING_IF_IF,” and “USING_SELECTION” in the example above, refers to the particular type of HL CFC instruction set to be used by the compiler, where the phrases “USING_MIX,” “USING_MATRIX,” “USING_IF_ELSE,” “USING_IF_IF,” and “USING_SELECTION” refer to Boolean variables. If the Boolean variable for one of these is set to one and the others to zero, the compiler uses that type of HL CFC instruction set, e.g., the corresponding ‘mix” or linear interpolation type, matrix or polynomial fitting type, if-else type, if-if type, or “:?” or selection type of HL CFC instruction set. In effect, compiler directives may be used to approximate the interface and CFC translation manager module in compilers that do not currently provide such features. These compiler directives may be considered the equivalent although less elegant and more likely less efficient form of translation modules 26.

For the “USING_MATRIX” translation, the instantiated 4×4 matrix referred to as “m4sel” in the pseudo-code above may be pre-calculated into a coefficient matrix such that the following set of polynomials:

y1(x)=coef_{—}11+coef_{—}12*x+coef_{—}13*x2+coef_{—}14*x3;

y2(x)=coef_{—}21+coef_{—}22*x+coef_{—}23*x2+coef_{—}24*x3;

y3(x)=coef_{—}31+coef_{—}32*x+coef_{—}33*x2+coef_{—}34*x3; and

y4(x)=coef_{—}41+coef_{—}42*x+coef_{—}43*x2+coef_{—}44*x3,

satisfies the following set of conditions:

(y1, y2, y3, y4)=(1, 0, 0, 0), if x=1;

(y1, y2, y3, y4)=(0, 1, 0, 0), if x=2;

(y1, y2, y3, y4)=(0, 0, 1, 0), if x=5; and

(y1, y2, y3, y4)=(0, 0, 0, 1), if x=9.

Between the “#ifdef” and “#endif” expressions are the resulting translated set of HL CFC instructions that will be produced when invoking each of what may be characterized as psudo-translation modules 26. That is, the translation of a HL CFC instruction set specified by a developer, such as developer 13, does not occur in this example. Rather developer 13 defines values for each of variables val_{—}2, val_{—}3, val_{—}4 and defines arithmetic expressions arith_expr_{—}1, arith_expr_{—}2, arith_expr_{—}3, arith_expr_{—}4 and then invokes each of translation modules to produce the instructions shown above between the “#ifdef” and “#endif” expressions, which is then provided to CFC compilers 42 in the form of candidate HL CFC instruction sets 36A. This is similar to receiving a HL CFC instruction set 32A and then translating this HL CFC instruction set 32A into each of the types of HL CFC instruction sets listed above and achieves a similar result. The pseudo-code above may be used in less formal instances where a formal user interface is not provided by which to define translation modules 26. Thus, while generally described as involving a translation from one type of HL CFC instruction set to other types of HL CFC instructions sets, the techniques may be implemented in any number of ways including that described above with respect to the pseudo-code and should not be limited to any one type of implementation.

In any event, comparison module 46 receives each of candidate LL CFC instruction sets 44 produced by CFC compilers 42 in response to receiving translated HL CFC instruction sets 36. Comparison module 46 determines execution metrics for each of candidate LL CFC instruction sets 44. For translated HL CFC instruction sets 36 produced in accordance with the above noted pseudo-code, comparison module 46 may determine the following example execution metrics shown in the following Table 1 for the corresponding candidate LL CFC instruction sets:

TABLE 1

| | Code Size | | Instructions |
|---|---|---|---|
| Formulation | (Bytes) | GPRs/Threads | (Fetches + ALUs) |
| USING_IF_ELSE | 348 | 4 | 1 + 21 |
| USING_IF_IF | 288 | 3 | 1 + 17 |
| USING_SELECTION | 288 | 3 | 1 + 17 |
| USING_MIX | 192 | 4 | 1 + 13 |
| USING_MATRIX | 132 | 4 | 1 + 8 |

In the above Table 1, candidate LL CFC instruction set 44D resulting from compiling translated HL CFC instruction set 36D produced by linear interpolation module 26D (and labeled “USING_MIX” in Table 1 above) outperforms the best of LL CFC instructions sets 44A-44C corresponding to translated HL CFC instruction sets 36A-36C produced by translation modules 26A-26C by 33% in code size and 23% in fetches and arithmetic logic unit (ALU) or arithmetic operations. Candidate LL CFC instruction set 44N resulting from compiling translated HL CFC instruction set 36N produced by polynomial fitting translation module 26N (and labeled “USING_MATRIX” in Table 1 above) outperforms the best of LL CFC instructions sets 44A-44C corresponding to translated HL CFC instruction sets 36A-36C produced by translation modules 26A-26C by 54% in code size and 52% in fetches plus ALU operations. In both instances, the number of general purpose registers (GPRs) used per thread of execution is similar and only varies by one. The metrics represent how one particular compiler may compile each of the instruction sets and other compilers may compile these or similar instruction sets in a different manner that results in different metrics. The techniques should not be limited to the example metrics set forth in Table 1, but may generally be applied by any compiler to improve compilation of functionally equivalent instructions sets.

In this respect, linear interpolation translation module 26D and polynomial fitting translation module 26N produce HL CFC instruction sets 36D, 36N that are more efficient in terms of code size, as measured in bytes, and arithmetic operations, as measured in terms of instruction fetches and arithmetic logic unit (ALU) operations, and similar in terms of GPRs used per thread. The reduction in code size and instruction fetches and ALU operations for these alternative CFC implementations occurs as a result of leveraging GPU's that have optimized hardware for performing these operations. Thus, while these alternative CFC operations may be more efficient in certain contexts, these alternative CFC instruction sets involving linear interpolation and polynomial fitting may not always produce the most efficient HL CFC instruction set in all instances.

For this reason, comparison module 46 performs evaluation of all of candidate LL CFC instruction sets 44, although this aspect of the techniques may be adapted in any number of ways to reduce the number or frequency of comparisons. For example, comparison module 46 may enable some type of “hint,” such as other compiler directive that developer 13 may insert into the HL code 22, to signal certain contexts in which one translation may be known to be most efficient than the others. Alternatively, compiler 20 may map, identify or otherwise develop a context map that indicates criteria by which to identify these contexts automatically. In any event, the techniques should not be limited to the example described above in which CFC translation manager module 28 always invokes translation modules 26 for each and every one of HL CFC instruction sets 32.

Returning to the example above, comparison module 46 selects candidate LL CFC instruction set 44N based on the execution metrics provided above in Table 1. Comparison module 46 then outputs LL CFC instruction set 44N as LL CFC instruction sets 38A of LL code 34. CFC translation manager module 28 may then perform this same process for each of or one or more of HL CFC instruction sets 32.

In this way, compiler 20, as a result of implementing the techniques described in this disclosure, may provide an extensible compiler module that provides an interface by which to receive additional translation modules not commonly provided with currently available commercial compilers, such as linear interpolation translation module 26D and polynomial fitting translation module 26N. With these alternative translation modules 26D, 26N, compiler 20 may produce LL code 34 that potentially exceeds that produced by the currently available commercial compilers in terms of the performance of CFC, at least as measured in terms of the above noted execution metrics. Moreover, compiler 20 is more adaptive to different programming scenarios, variations in platform hardware (such as the presence of a GPU) and the like in that the various translation modules may each be adapted to certain contexts, programming scenarios and variation in platform hardware. Compiler 20 also allows the use of desired formulation for intuitive HL CFC representation without being limited to a single compilation of such HL CFC instruction sets that may or may not be most efficient in comparison to other available HL CFC representations.

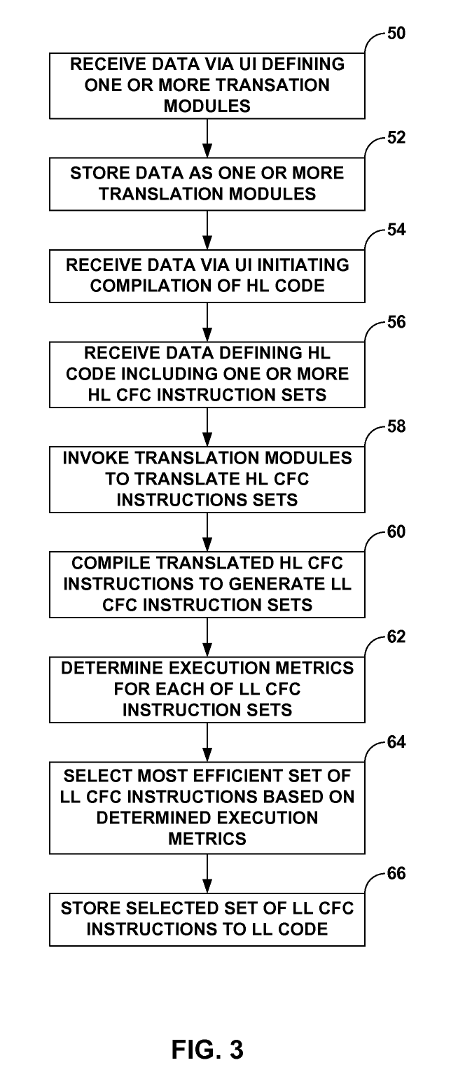

FIG. 3 is a flowchart illustrating example operation of a compiler, such as compiler 20 of computing device 12 shown in the example of FIG. 1, in implementing various aspect of the efficient CFC compilation techniques described in this disclosure. Compiler 20 initially receives data via a user interface provided by configuration interface module 24 and presented by user interface module 16 defining one or more of translation modules 26 in the manner described above (50). CFC translation manager module 28 of compiler 20 stores this data as one or more of translation modules 26 (52). Compiler 20 then receives data via a user interface presented via UI module 16 that initiates the compilation of HL code 22, which may have been previously defined by developer 13 (54). Compiler 20 then receives data defining HL code 22 that includes one or more HL CFC instruction sets 32 from software development module 18 (56).

Upon receiving this HL code 22, compiler 20 begins compiling HL code 22 to generate LL code 34. In compiling HL code 22, compiler 20 encounters HL CFC instruction sets 32. For each one of HL CFC instruction sets 32, compiler 20 invokes CFC translation manager module 28 to compile each one of HL CFC instructions sets 32. CFC translation manager module 28 invokes one or more of translation modules 26 in the manner described above to translate HL CFC instruction sets 26 into translated HL CFC instruction sets 36 (58). CFC translation manager module 28 includes an evaluation module 30 that performs the compilation of translated HL CFC instruction sets 26 and subsequent evaluation of candidate LL CFC instruction sets 44 produced from compilation. As shown in the example of FIG. 2, evaluation module 30 includes CFC compilers 42. Each of CFC compilers 42 compiles a corresponding one of translated HL CFC instruction sets 36 to generate candidate LL CFC instruction sets 44 (60).

Evaluation module 30 also includes a comparison module 46. Comparison module 46 determines the above noted execution metrics for each of candidate LL CFC instruction sets 44 (62). Again, the execution metrics may include one or more of a number of low-level instructions, memory consumed by the low-level instructions and general purpose registers utilized per thread. Comparison module 46 compares each of these candidate LL CFC instruction sets 44 to select the most efficient candidate LL CFC instruction set 44 based on the determined execution metrics (64). Comparison module 46 then stores the selected one of LL CFC instruction sets 44 to LL code 34 as one of LL CFC instructions 38 (66). LL code 34, again, represents an executable file that is capable of execution by a user device, such as a handset or a cellular telephone. This executable file may represent a so-called “app” that such a user device is capable of executing. The user device may download or otherwise retrieve this app, load or install this app, and execute the app to perform the functionality provided the LL code 34. In any event, the techniques may provide for a compiler that identifies a most efficient form of CFC of all available forms without imposing unnecessary platform-specific constraints beyond the standard application programmer interfaces (APIs) provided for interfacing with a particular GPU shader or kernel.

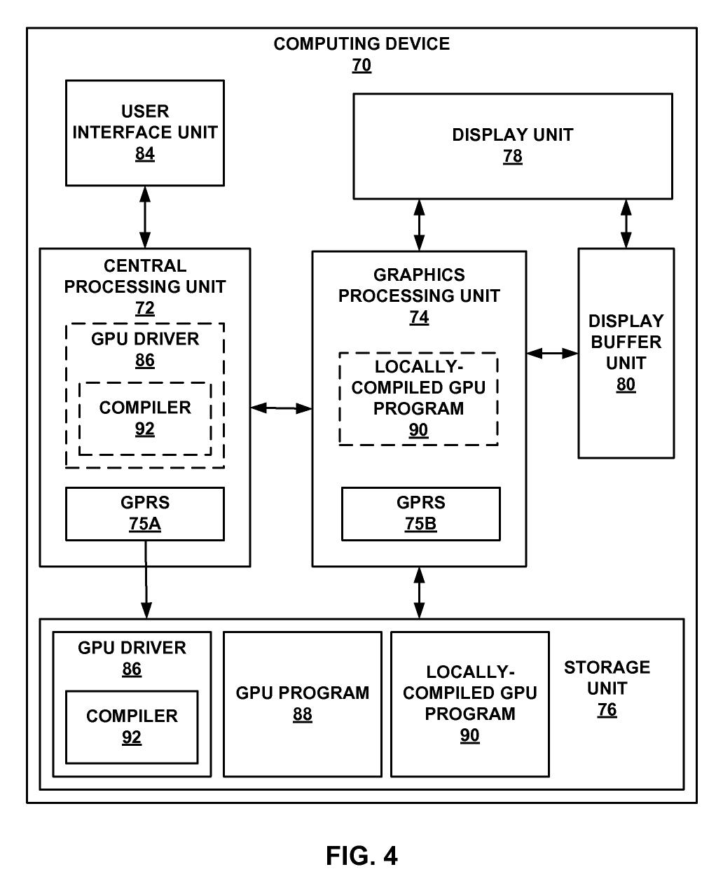

FIG. 4 is a block diagram illustrating another computing device 70 that may implement the techniques described in this disclosure. In the example of FIG. 4, computing device 70 represents a mobile device, such as any combination of a cellular phone (including so-called “smart phones”), a laptop computer, and a so-called “netbook,” or a personal digital assistant (PDA), a digital media player, a gaming device a geographical positioning system (GPS) unit, an embedded system, a portable media systems, or any other type of computing device that typically implement or support OpenGL ES in accordance with the OpenGL ES specification. [but not limited to mobile devices]

In the example of FIG. 4, computing device 70 includes a central processing unit (CPU) 72, a graphics processing unit (GPU) 74, a storage unit 76, a display unit 78, a display buffer unit 80, and a user interface unit 84. In one example, control unit 14 shown in the example of FIG. 1 may comprise units 72-76 and 80. Although CPU 72 and GPU 74 are illustrated as separate units in the example of FIG. 3, CPU 72 and GPU 74 may be integrated into a single unit, such as in the case when the GPU is integrated into the CPU. CPU 72 represents one or more processors that are capable of executing machine or LL instructions.

GPU 74 represents one or more dedicated processors for performing graphical operations. In some instances, GPU 74 may provide three levels of parallelism. GPU 74 may provide a first level of parallelism in the form of parallel processing of four color channels. GPU 74 may provide a second level of parallelism in the form of hardware thread interleaving to process pixels and a second level of parallelism in the form of dynamic software thread interleaving.

Each of CPU 72 and GPU 74 also include general purpose registers (GPRs) 75A, 75B (“GPRs 75”). GPRs 75 represent on-chip storage or memory used in executing machine or object code. GPRs 75 may each comprise a hardware memory register capable of storing a fixed number of digital bits. CPU 72 and GPU 74 may be able to read values from or write values to GPRs 76 more quickly than reading values from or writing values to storage device unit 76. As described in more detail, compiled GPU program 86 may indicate which ones of GPRs 75 should be used to store values used by compiled GPU program 86.

Storage unit 76 may comprise one or more computer-readable storage media. Examples of storage unit 76 include, but are not limited to, a random access memory (RAM), a read only memory (ROM), an electrically erasable programmable read-only memory (EEPROM), CD-ROM or other optical disk storage, magnetic disk storage, or other magnetic storage devices, flash memory, or any other medium that can be used to store desired program code in the form of instructions or data structures and that can be accessed by a computer or a processor. In some example implementations, storage device 76 may include instructions that cause CPU 72 and/or GPU 74 to perform the functions ascribed to processor 72 and GPU 74 in this disclosure. Storage unit 76 may, in some examples, be considered as a non-transitory storage medium. The term “non-transitory” may indicate that the storage medium is not embodied in a carrier wave or a propagated signal. However, the term “non-transitory” should not be interpreted to mean that storage unit 76 is non-movable. As one example, storage unit 76 may be removed from computing device 70, and moved to another device. As another example, a storage unit, substantially similar to storage unit 76, may be inserted into computing device 70. In certain examples, a non-transitory storage medium may store data that can, over time, change (e.g., in RAM).

Display unit 78 represents a unit capable of displaying video data, images, text or any other type of data for consumption by a viewer. Display unit 78 may include a liquid-crystal display (LCD), a light emitting diode (LED) display, an organic LED (OLED), an active-matrix OLED (AMOLED) display, or the like. Display buffer unit 80 represents a memory or storage device dedicated to storing data for display unit 78. User interface unit 84 represents a unit with which a user may interact with or otherwise interface to communicate with other units of computing device 70, such as CPU 72. Examples of user interface unit 84 include, but are not limited to, a trackball, a mouse, a keyboard, and other types of input devices. User interface unit 84 may also be a touch screen and may be incorporated as a part of display unit 78.

Computing device 70 may include additional modules or units not shown in FIG. 3 for purposes of clarity. For example, computing device 70 may include a speaker and a microphone, neither of which are shown in FIG. 3, to effectuate telephonic communications in examples where computing device 70 is a mobile wireless telephone, or a speaker where computing device 70 is a media player. In some instances, user interface unit 84 and display unit 78 may be external to computing device 78 in examples where computing device 78 is a desktop computer or other device that is equipped to interface with an external user interface or display.

As illustrated in the example of FIG. 4, storage unit 76 stores a GPU driver 86, GPU program 88, and compiler 90. GPU driver 86 represents a computer program or executable that provides an interface to access GPU 74. CPU 72 executes GPU driver 86 or portions thereof to interface with GPU 74 and, for this reason, GPU driver 86 is shown in the example of FIG. 3 as a dash-lined box labeled “GPU driver 86” within CPU 72. GPU driver 86 is accessible to programs or other executables executed by CPU 72, including GPU program 88. GPU program 88 may comprise a program written in a HL programming language, such as an Open-Computing Language (which is known commonly as “OpenCL”) and/or OpenGL ES that utilizes the dedicated GPU-specific operations provided by GPU 88. GPU programs developed using the OpenGL specification may be referred to as shader programs. Alternatively, GPU programs developed using the OpenCL specification may be referred to as program kernels. GPU program 88 may be embedded or otherwise included within another program executing on CPU 72.

GPU program 88 may invoke or otherwise include one or more functions provided by GPU driver 86. CPU 72 generally executes the program in which GPU program 88 is embedded and, upon encountering GPU program 88, passes GPU program 88 to GPU driver 86. CPU 72 executes GPU driver 86 in this context to process GPU program 88, where GPU driver 86 processes GPU program 88 in this instance by compiling GPU program 88 into object or machine code executable by GPU 74. This object code is shown in the example of FIG. 3 as locally compiled GPU program 90.

To compile this GPU program 88, GPU driver 86 includes a compiler 92 that compiles GPU program 88 utilizing the efficient CFC compilation techniques described in this disclosure. Compiler 92 may be substantially similar to compiler 20 described above with respect to FIGS. 1-3, except that compiler 92 operates in real-time or near-real-time to compile GPU program 88 during the execution of the program in which GPU program 88 is embedded. Although not shown in the example of FIG. 4, compiler 92, similar to compiler 20, includes an interface by which to receive translation modules similar to translation modules 26 and a CFC translation manager module similar to CFC translation manager module 28 to store these translation modules. This CFC translation manager module may implement other aspects of the techniques described herein to compile translated HL CFC instruction sets to generate candidate LL CFC instruction sets, evaluate these LL CFC instruction sets and select the most efficient one of the candidate LL CFC instruction sets to produce LL CFC instruction sets of locally-compiled GPU program 90.

For example, compiler 92 may receive GPU program 88 from CPU 72 when executing HL code that includes GPU program 88. Compiler 92 may compile GPU program 88 to generate locally-compiled GPU program 90 that conforms to a LL programming language. In some examples, GPU program 90 may be defined in accordance with an OpenGL ES shading language. GPU program 88 may include HL CFC instructions that compiler 92 compiles in accordance with the efficient CFC compilation techniques described in this disclosure with respect to compiler 20 as referred to in the above described examples of FIGS. 1-3. Compiler 92 then outputs locally-compiled GPU program 90 that includes the LL CFC instruction sets generated through application of the techniques described in this disclosure by compiler 92.

GPU 74 generally receives locally-compiled GPU program 90 (as shown by the dashed lined box labeled “locally-compiled GPU program 90” within GPU 74), whereupon, in some instances, GPU 74 renders an image and outputs the rendered portions of the image to display buffer unit 80. Display buffer unit 80 may temporarily store the rendered pixels of the rendered image until the entire image is rendered. Display buffer unit 80 may be considered as an image frame buffer in this context. Display buffer unit 80 may then transmit the rendered image to be displayed on display unit 48. In some alternate examples, GPU 74 may output the rendered portions of the image directly to display unit 78 for display, rather than temporarily storing the image in display buffer unit 80. Display unit 78 may then display the image stored in display buffer unit 78.

In this way, the techniques of this disclosure may be executed in a real-time or near-real-time environment to provide an efficient reduction of HL CFC instruction sets to LL CFC instruction sets capable of being executed by a GPU. The developer of the HL code, with one example being HL code that includes a GPU program, may not have to remember to use a certain type of HL CFC instruction in certain contexts and may relay on the compiler that operates in accordance with the techniques described in this disclosure to select the most efficient available type of HL CFC instruction set. The techniques may therefore remove inefficiencies inherent in currently available compilers that may impede execution of programs or other executable that rely on real-time or near-real-time compilation.

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of compiling high-level software instructions to generate low-level software instructions, the method comprising:
translating, with a computing device, a first set of the high-level conditional flow control (CFC) software instructions to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions;
compiling, with the computing device, the first and second sets of high-level CFC software instructions to a respective first and second set of low-level CFC software instructions;
determining, with the computing device, which of the first and second sets of the low-level CFC software instructions is more efficient as measured in terms of at least one execution metric; and
selecting, with the computing device, the one of the first and second low-level CFC software instructions determined to be more efficient, wherein the low-level software instructions include the one of the first and second sets of the low-level CFC software instructions that is determined as more efficient.

2. The method of claim 1, further comprising presenting an interface by which to receive a translation module that translates a given type of HL CFC instruction set to a particular type of functionally equivalent HL CFC instruction set,
wherein translating the first set of high-level CFC software instructions includes translating the first set of high-level CFC instructions with the translation module to generate the second set of high-level CFC software instructions in the particular type specified by the translation module.

3. The method of claim 1, wherein the second set of high-level CFC software instructions include:
an instruction to instantiate a matrix; and
at least one comparison of a variable to a value that is performed by an instruction that causes a graphics processing unit to perform matrix multiplication multiplying the instantiated matrix by at least one value.

4. The method of claim 1, wherein the second set of high-level CFC software instructions include at least one comparison of a variable to a value that is performed by an instruction that causes a graphics processing unit to perform a form of linear interpolation.

5. The method of claim 4, wherein the instruction that causes a graphics processing unit to perform a form of linear interpolation comprises a mix instruction for which the graphics processing unit provides a special hardware implementation to accelerate the execution of the mix instruction.

6. The method of claim 1,
wherein the computing device includes a central processing unit (CPU) that executes a software driver and a graphics processing unit (GPU),
wherein the software drive includes a compiler, and
wherein compiling the first and second sets of high-level CFC software instructions includes executing the software driver with the CPU to compile with the compiler the first and second sets of high-level CFC software instructions in order to generate the low-level-software instructions for execution by the GPU.

7. The method of claim 1, wherein the high-level software instructions comprise software instructions that conform to those specified by an Open Graphics Library Embedded Systems (OpenGL ES) shading language.

8. The method of claim 1, wherein determining which of the first and second sets of the low-level CFC software instructions is more efficient comprises determining which of the first and second sets of the low-level CFC software instructions is more efficient as measured in terms of at least one a combination of one or more of a number of low-level instructions, memory consumed by the low-level instructions and general purpose registers utilized per thread.

9. The method of claim 1, wherein the computing device comprises a mobile device.

10. An apparatus that compiles high-level software instructions to generate low-level software instructions, the apparatus comprising:
a processor that executes a compiler to translate a first set of high-level conditional flow control (CFC) software instructions included within the high-level software instructions to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions,
wherein the compiler further compiles the first and second sets of high-level CFC software instructions to a respective first and second set of low-level CFC software instructions,
wherein the compiler includes an evaluation module that determines which of the first and second sets of the low-level CFC software instructions is more efficient as measured in terms of at least one execution metric and selects the one of the first and second low-level CFC software instructions determined to be most efficient, wherein the low-level software instructions include the one of the first and second sets of the low-level CFC software instructions that is determined as most efficient.

11. The apparatus of claim 10, wherein the processor executes a user interface module that presents an interface by which to receive a translation module that translates a given type of HL CFC instruction set to a particular type of functionally equivalent HL CFC instruction set,
wherein the compiler executes the translation module to translate the first set of high-level CFC instructions so as to generate the second set of high-level CFC software instructions in the particular type specified by the translation module.

12. The apparatus of claim 10, further comprising a graphics processing unit (GPU),
wherein the second set of high-level CFC software instructions include:
an instruction to instantiate a matrix; and
at least one comparison of a variable to a value that is performed by an instruction that causes the GPU to perform matrix multiplication multiplying the instantiated matrix by at least one value.

13. The apparatus of claim 10, further comprising a graphics processing unit (GPU), wherein the second set of high-level CFC software instructions include at least one comparison of a variable to a value that is performed by an instruction that causes the GPU to perform a form of linear interpolation.

14. The apparatus of claim 13,
wherein the GPU implements the form of linear interpolation as a mix instruction, and
wherein the GPU includes a special hardware implementation of the mix instruction that accelerates the execution of the mix instruction.

15. The apparatus of claim 10,
wherein the processor comprises a central processing unit (CPU),
wherein the CPU executes a software driver,
wherein the software driver includes the compiler,
wherein the apparatus further comprises a graphics processing unit (GPU), and
wherein the CPU executes the software driver to invoke the compiler to translate the high-level software instructions in order to generate the low-level-software instructions for execution by the GPU.

16. The apparatus of claim 10, wherein the high-level software instructions comprise software instructions that conform to those specified by an Open Graphics Library Embedded Systems (OpenGL ES) shading language.

17. The apparatus of claim 10, wherein the compiler determines which of the first and second sets of the low-level CFC software instructions is more efficient as measured in terms of at least one a combination of one or more of a number of low-level instructions, memory consumed by the low-level instructions and general purpose registers utilized per thread.

18. The apparatus of claim 10, wherein the apparatus comprises a mobile device.

19. An apparatus that compiles high-level software instructions to generate low-level software instructions, the apparatus comprising:
means for translating a first set of high-level conditional flow control (CFC) software instructions included within the high-level software instruction to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions;
means for compiling the first and second sets of high-level CFC software instructions to a respective first and second set of low-level CFC software instructions;
means determining which of the first and second sets of the low-level CFC software instructions is most efficient as measured in terms of at least one execution metric; and
means for selecting the one of the first and second low-level CFC software instructions determined to be most efficient, wherein the low-level software instructions include the one of the first and second sets of the low-level CFC software instructions that is determined as more efficient.

20. The apparatus of claim 19, further comprising means for presenting an interface by which to receive a translation module that translates a given type of HL CFC instruction set to a particular type of functionally equivalent HL CFC instruction set,
wherein the means for translating the first set of high-level CFC software instructions includes the translation module that translates the first set of high-level CFC instructions to generate the second set of high-level CFC software instructions in the particular type specified by the translation module.

21. The apparatus of claim 19, further comprising a graphics processing unit (GPU),
wherein the second set of high-level CFC software instructions include:
an instruction to instantiate a matrix; and
at least one comparison of a variable to a value that is performed by an instruction that causes the GPU to perform matrix multiplication multiplying the instantiated matrix by at least one value.

22. The apparatus of claim 19, further comprising a graphics processing unit (GPU), wherein the second set of high-level CFC software instructions include at least one comparison of a variable to a value that is performed by an instruction that causes the GPU to perform a form of linear interpolation.

23. The apparatus of claim 22,
wherein the GPU implements the form of linear interpolation as a mix instruction, and
wherein the GPU includes a special hardware implementation of the mix instruction that accelerates the execution of the mix instruction.

24. The apparatus of claim 19, further comprising a central processing unit (CPU) and a graphics processing unit (GPU),
wherein the means for compiling comprises a compiler included within a software driver executed by the CPU, and
wherein the CPU executes the software driver to invoke the compiler to translate the high-level software instructions in order to generate the low-level-software instructions for execution by the GPU.

25. The apparatus of claim 19, wherein the high-level software instructions comprise software instructions that conform to those specified by an Open Graphics Library Embedded Systems (OpenGL ES) shading language.

26. The apparatus of claim 19, wherein the means for determining which of the first and second sets of the low-level CFC software instructions is more efficient comprises means for determining which of the first and second sets of the low-level CFC software instructions is more efficient as measured in terms of at least one a combination of one or more of a number of low-level instructions, memory consumed by the low-level instructions and general purpose registers utilized per thread.

27. The method of claim 19, wherein the apparatus comprises a mobile device.

28. A non-transitory computer-readable medium comprising instructions that cause, when executed, one or more processors to:
translate a first set of high-level conditional flow control (CFC) software instructions included within the high-level software instruction to a functionally equivalent but different second set of high-level CFC software instructions, wherein the first set of high-level conditional flow control (CFC) software instructions control execution of other ones of the high-level software instructions, and wherein the second set of high-level CFC software instructions control the execution of the other ones of the high-level software instructions in a manner functionally equivalent to that of the first set of high-level CFC software instructions;
compile the first and second sets of high-level CFC software instructions to a respective first and second set of low-level CFC software instructions;
determine which of the first and second sets of the low-level CFC software instructions is most efficient as measured in terms of at least one execution metric; and
select the one of the first and second low-level CFC software instructions determined to be most efficient, wherein the low-level software instructions include the one of the first and second sets of the low-level CFC software instructions that is determined as more efficient.

29. The non-transitory computer-readable medium of claim 28, further comprising instructions that cause, when executed, the one or more processors to:
present an interface by which to receive a translation module that translates a given type of HL CFC instruction set to a particular type of functionally equivalent HL CFC instruction set; and
translate the first set of high-level CFC instructions with the translation module to generate the second set of high-level CFC software instructions in the particular type specified by the translation module.

30. The non-transitory computer-readable medium of claim 28, wherein the second set of high-level CFC software instructions include:
an instruction to instantiate a matrix; and
at least one comparison of a variable to a value that is performed by an instruction that causes a graphics processing unit to perform matrix multiplication multiplying the instantiated matrix by at least one value.

31. The non-transitory computer-readable medium of claim 28, wherein the second set of high-level CFC software instructions include at least one comparison of a variable to a value that is performed by an instruction that causes a graphics processing unit to perform a form of linear interpolation.

32. The non-transitory computer-readable medium of claim 31, wherein the instruction that causes a graphics processing unit to perform a form of linear interpolation comprises a mix instruction for which the graphics processing unit provides a special hardware implementation to accelerate the execution of the mix instruction.

33. The non-transitory computer-readable medium of claim 28,
wherein the one or more processors includes a central processing unit (CPU) that executes a software driver and a graphics processing unit (GPU),
wherein the software drive includes a compiler, and
wherein the non-transitory computer-readable medium further comprises instructions that, when executed, cause the CPU to execute the software driver to compile with the compiler the first and second sets of high-level CFC software instructions in order to generate the low-level-software instructions for execution by the GPU.

34. The non-transitory computer-readable medium of claim 28, wherein the high-level software instructions comprise software instructions that conform to those specified by an Open Graphics Library Embedded Systems (OpenGL ES) shading language.

35. The non-transitory computer-readable medium of claim 28, further comprising instructions that cause, when executed, the one or more processors to determine which of the first and second sets of the low-level CFC software instructions is more efficient as measured in terms of at least one a combination of one or more of a number of low-level instructions, memory consumed by the low-level instructions and general purpose registers utilized per thread.
